(19) United States
(12) Patent Application Publication
(10) Pub. No.: US 2026/0127227 A1
(43) Pub. Date: May 7, 2026

(54) INTELLIGENT, CUSTOMIZABLE RAG WITH CONTEXTUAL COMPRESSION

(71) Applicant: Cisco Technology, Inc., San Jose, CA (US)

(72) Inventors: Ali Payani, Cupertino, CA (US); Mahesh Viswanathan, White Plains, CA (US); Andrea Morandi, Greenbrae, CA (US); Ramin Pishehvar, La Crescenta, CA (US)

(73) Assignee: Cisco Technology, Inc., San Jose, CA (US)

(21) Appl. No.: 18/936,539

(22) Filed: Nov. 4, 2024

(51) Int. Cl. G06F 16/903; G06F 16/908; G06F 16/93; G06F 40/30

(52) U.S. Cl. CPC G06F 16/90335; G06F 16/908; G06F 16/93; G06F 40/30

(57) ABSTRACT

In one implementation, a device retrieves a set of documents based on their relevancy to an input query from a user interface. The device extracts excerpts of varying sizes from the set of documents that are relevant to the input query. The device performs a ranking of the excerpts based on their relevancy to the input query. The device augments, based on the ranking, the input query based on one or more of the excerpts to form a prompt for input to a language model.

### TECHNICAL FIELD

The present disclosure relates generally to retrieval augmented generation (RAG) systems and more particularly to intelligent, customizable RAG with contextual compression.

### BACKGROUND

Recent advancements in artificial intelligence models (e.g., language models such as large language models (LLMs)), have opened new possibilities across various industries. Specifically, the ability of these models to follow instructions enables their integration with tools (e.g., plugins) that are able to perform tasks such as searching the web, executing code, etc.

Many LLM-based solutions utilize some form of document storage they can query against, e.g., vector databases. This allows for the retrieval of information specific and relevant to the query. For example, in Retrieval Augmented Generation (RAG) systems, the model responds to user queries with reference to a specified set of documents stored in a vector database and uses this information in preference to information drawn from its own large, static training data. Semantic search is customarily used for purposes of this type of information retrieval to select the most relevant documents which will be used to augment the query.

However, one challenge with semantic search is that the designer of the search system often does not know the specific queries that users will invoke for retrieval. This means that the information most relevant to a query may be buried in a document along with a lot of irrelevant text. In addition, the retrieved documents may also contain other topics that are somewhat related but not pertinent to the query. If all of these document sections are passed along to the LLM, the LLM may become confused and fail to provide the specific information that the user desires and reducing the accuracy of the system.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIG. 5 illustrates an example workflow for a retrieval augmented generation (RAG) system;

FIG. 6 illustrates an example of contextual compression in a RAG system;

FIG. 7 illustrates an example user interface for entry of a query; and

FIG. 8 illustrates an example of a simplified procedure for generating an output in a RAG system, in accordance with one or more implementations described herein.

### DESCRIPTION OF EXAMPLE IMPLEMENTATIONS

### Overview

According to one or more implementations of the disclosure, a device retrieves a set of documents based on their relevancy to an input query from a user interface. The device extracts excerpts of varying sizes from the set of documents that are relevant to the input query. The device performs a ranking of the excerpts based on their relevancy to the input query. The device augments, based on the ranking, the input query based on one or more of the excerpts to form a prompt for input to a language model.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

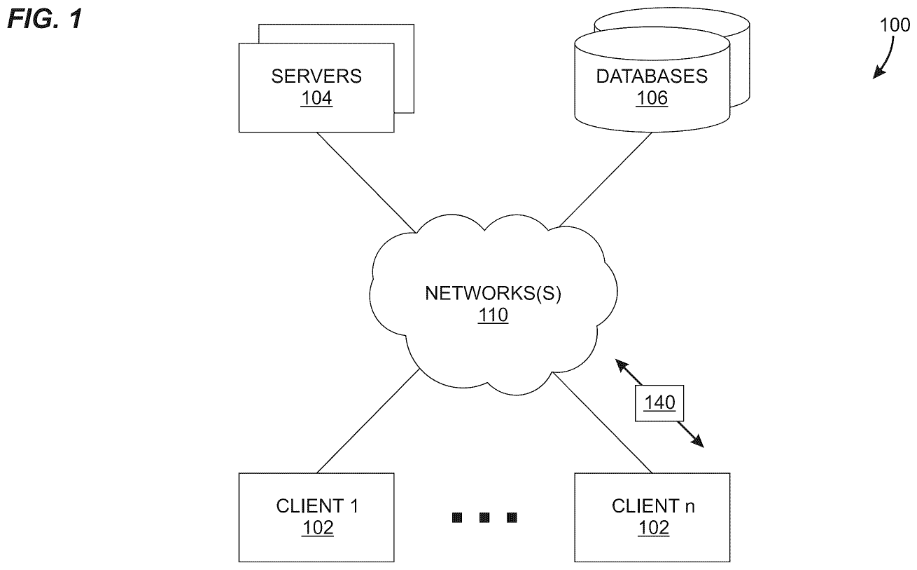

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IOT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (Saas) over a network, such as the Internet.

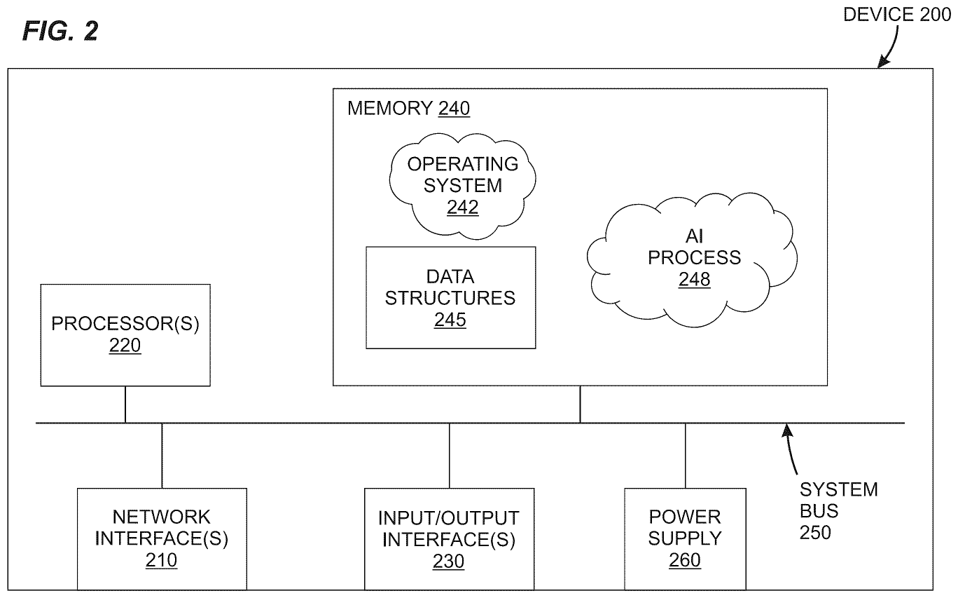

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may employ and/or be utilized to handle prompts to and/or access of one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

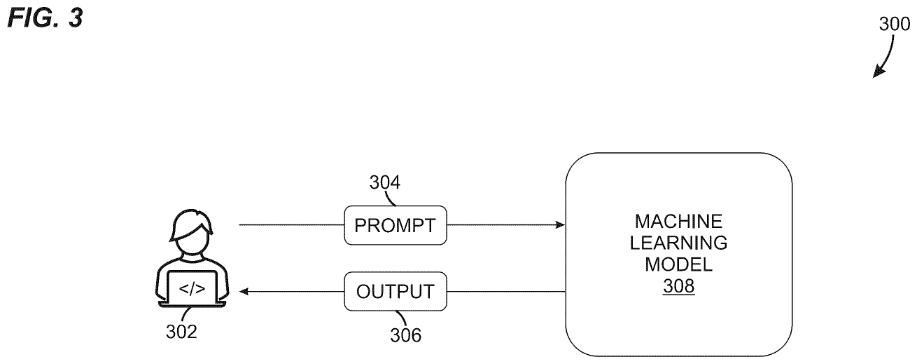

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

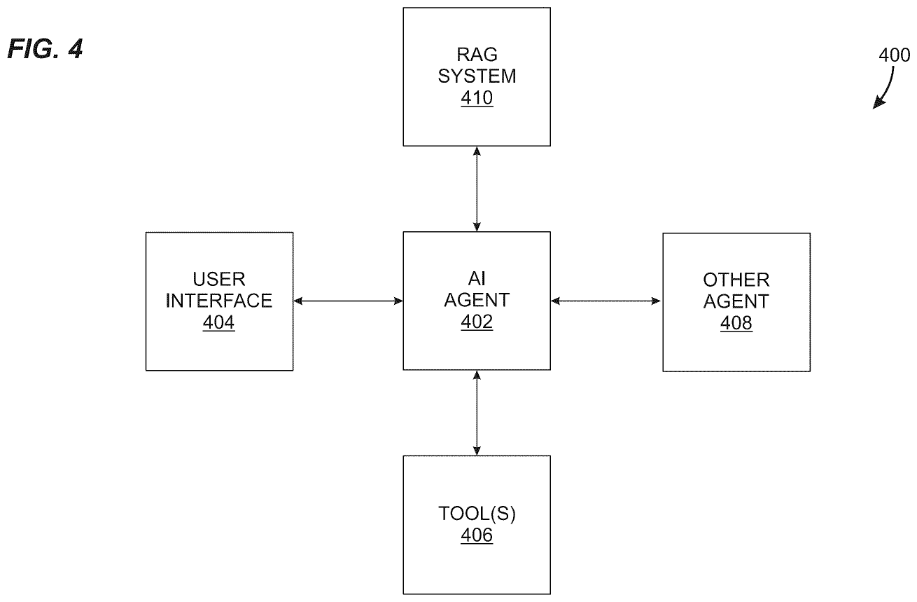

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

However, one challenge with respect to current RAG systems is that they are hamstrung by their static nature, relying heavily on a fixed, predefined selection of information chunks based on similarity scores. This approach severely limits their effectiveness, as it does not account for the varied and dynamic nature of user queries or the contextual richness that could be leveraged from a broader dataset. The rigidity of these systems, particularly in how they handle the finite context window available for generating responses, means they often miss opportunities to deliver truly relevant, personalized, and contextually appropriate content to users. This results in a one-size-fits-all model that fails to utilize the wealth of available information to its full potential, leading to responses that, while technically accurate, may not fully satisfy user inquiries or preferences.

In addition, traditional RAG systems rely on semantic search for purposes of information retrieval to select the most relevant documents for use to augment the query. However, one challenge with semantic search is that the designer of the search system often does not know the specific queries that users or agents will invoke for retrieval.

This means that the information that is most relevant to a query may be buried in a document along with a lot of irrelevant text. In addition, the retrieved documents may also include other topics that are somewhat related, but not pertinent, to the intended query. If all of these document sections are passed along to the LLM, the LLM may become confused and fail to provide the specific information that the user desires and reducing the accuracy of the system.

### Intelligent, Customizable Rag with Contextual Compression

The techniques herein introduce an intelligent RAG system that has context-awareness, allowing it to better ensure the relevancy of the context that it adds to a prompt. Further aspects of the techniques herein relate to a contextual compression approach that is query-dependent, thereby providing only those portions of a document or set of documents for input to a large language model (LLM) and improving the accuracy of the final answer.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device retrieves a set of documents based on their relevancy to an input query from a user interface. The device extracts excerpts of varying sizes from the set of documents that are relevant to the input query. The device performs a ranking of the excerpts based on their relevancy to the input query. The device augments, based on the ranking, the input query based on one or more of the excerpts to form a prompt for input to a language model.

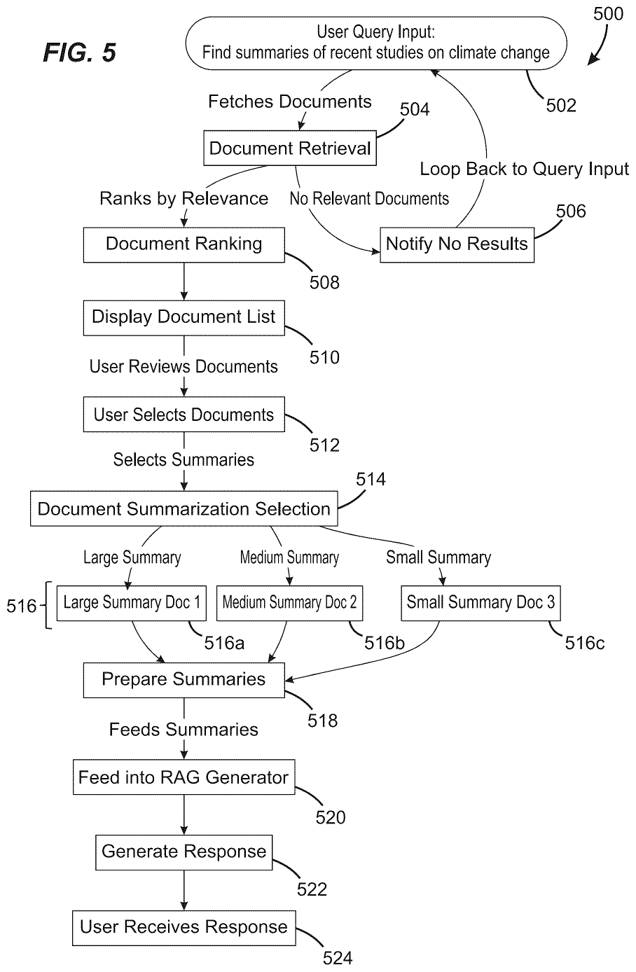

Operationally, FIG. 5 illustrates an example workflow 500 for a retrieval augmented generation (RAG) system, according to various implementations. In some implementations, RAG system 410 may perform any or all of the steps of workflow 500, to provide an interactive RAG solution (e.g., through execution of AI process 248). This solution allows users to dictate the level of summarization for the documents that they wish to incorporate into the RAG system. By pre-storing documents at multiple summarization levels, the system allows users to choose not only which documents to include, but also their order and level of detail. This flexibility extends to how these documents are integrated into the generated content, enabling users to place them at various points throughout the response, rather than just at the beginning.

As shown, workflow 500 may start at step 502 in which a user inputs a query. For instance, assume that the user inputs the query, “Find summaries of recent studies in climate change.” In such a case, workflow 500 may proceed to step 504, where the system performs a document retrieval of the relevant documents. From there, if there are no documents that are relevant to the query, the system may notify the user at step 506 and return processing back to step 502.

However, if the RAG system does fetch any documents related to the query, workflow 500 may then proceed to step 508, where the system then ranks those documents by their relevancy. For instance, the system may perform semantic matching to fetch those documents and rank the documents by the degree to which they match the query. The RAG system may then display the matching documents to the user at step 510. In doing so, the RAG system may also indicate their ranking either explicitly (e.g., by displaying their rankings as well) or implicitly (e.g., by ordering the documents on the display).

At step 512, the RAG system may then ask the user to select those document(s) that the user views as particularly relevant to their query. In turn, the workflow may then proceed to step 514 where the RAG system may select summaries for those selected documents to the user. To do so, the RAG system may determine the optimal level of detail for each document within the constraints of the context window using an optimization approach to find the optimal combination of content. Doing so ensures that the RAG output is as informative and relevant as possible given the available space. In some implementations, the RAG system may produce the documents summaries using a smaller, more focused LLM or other generative model.

Consequently, as shown, the RAG system may generate summaries 516 that vary in size depending on their content and relevancy. For instance, the RAG system may generate a large summary of a first document at step 516a (e.g., multiple paragraphs), a medium sized summary of a second document at step 516b (e.g., a few sentences or a paragraph), and a smaller sized summary of a third document at step 516c (e.g., a single sentence). Of course, the sizes of the document summaries may vary, depending on the implementation.

As would be appreciated, this context-aware summarization helps the RAG system to augment a prompt in a manner that is both highly relevant to the query of the user and succinct for input to the LLM. At step 518, the RAG system may then prepare the summaries and input them to its generator at step 520, thereby ingesting those document summaries for use. At step 522, the RAG system may then generate a response to the query and provide it to the user at step 524 for review.

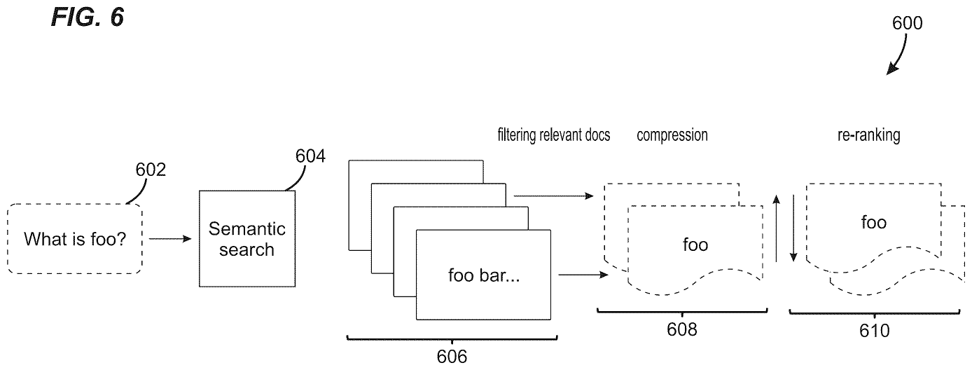

Continuing this concept of optimizing the RAG system to the specific needs of a user's query, FIG. 6 illustrates an example 600 of contextual compression in a RAG system that could be used, according to various implementations. In some instances, the RAG system in FIG. 5 could use the approach shown in FIG. 5 for purposes of its document selection, ranking, and summarization. In other instances, the RAG system may use the approach shown on the fly, as new queries are input to the system.

In some implementations, the RAG system may leverage multiple agents to perform searching the documents and is contextually sensitive to the user's query, thereby rendering the retrieved results far more relevant to the user's query. More specifically, a query-dependent approach is introduced herein for searching large documents for nuggets of relevant information using a 3-step approach referred to herein as contextual compression.

As shown, again consider the case in which a user issues an initial query 602. For instance, the user may ask the question, “What is foo?” In turn, the RAG system may perform semantic searching 604 across its document base, to identify those documents 606 that are relevant to the initial query 602. In some implementations, the RAG system may do so using any suitable searching algorithm. In further implementations, the RAG system may do so by leveraging enhanced reasoning capabilities, such as chain-of-thought reasoning and filtering for these documents 608 from among documents 606 that are the most relevant (e.g., above a relevancy threshold).

In various implementations, the RAG system then “compresses” the retrieved documents using the query, so that only the relevant information is returned. As shown, for instance, assume that one of documents 606 includes “foo bar,” but only the context “foo,” is actually relevant to the initial query 602. “Compression” here refers to both extracting sentences or other sub-portions from the retrieved documents relevant to the query and filtering out the irrelevant information. This makes the retrieval process query dependent.

In some implementations, the RAG system may then perform a reranking 610 of documents 608. For instance, the RAG system may do so at runtime by converting into an embedding representation and raking them by cosine similarity with respect to the query embeddings.

By way of example, consider the case of a user issuing the query, “How many national guard members were deployed on January 6?” As part of its initial processing, the system may then retrieve the following quotations from two documents via semantic search:

### Document 1

“On January 6, a mob of thousands of Trump supporters violently stormed the Capitol in the hope of overturning Biden's election, forcing Congress to evacuate during the counting of the Electoral College votes. More than 26,000 National Guard members were deployed to the capital for the inauguration, with thousands remaining into the spring.”

### Document 2

“[Abridged] WASHINGTON—Once the reality of the assault on the U.S. Capitol became apparent, National Guard troops responded appropriately and with alacrity, Department of Defense officials said in a briefing on the January 6 events.[. . . ]

Acting Defense Secretary Chris Miller immediately called up 1,100 members of the D.C. National Guard. At the same time, officials were collecting Guardsmen at traffic points and Metro stations and returning them to the D.C. Armory to refit for a crowd control mission, the secretary said. Their mission was to support D.C. Metropolitan Police and Capitol Hill Police. Guardsmen started flowing into the area of the Capitol soon after and reinforced Metro Police on the perimeter of the Capitol. This allowed the police and FBI to clear the chambers and offices of the U.S. Capitol, McCarthy said. “By 7:15, both chambers and leadership offices were cleared, and members were able to return to business, and we began the planning for the following day,” he said. At 6 p.m., Miller authorized the mobilization of up to 6,200 National Guard members from Maryland, Virginia, New York, New Jersey, Delaware and Pennsylvania. These service members will flow into the city over the next few days and will help secure the peaceful transfer of power to President-elect Joseph Biden on January 20.”

Here, the semantic search may rank Document 1 ahead of Document 2. Note that Document 1 is very short and succinct, while Document 2 is verbose. However, Document 2 does contain the relevant information (highlighted in bold and italics) buried within a lot of “noisy” text.

In such a case, the contextual compression mechanism of the RAG system may select and compress only the documents that are relevant to the query. Thus, in the example above, it may discard Document 1, since it does not specify how many national guards were deployed on January 6, but rather for the presidential inauguration. The system then selects Document 2 and extracts just those portions of the document that are relevant to answer the question (i.e., those portions above highlighted in bold and italics).

The end result is that the system generates a very short extract from Document 2 that contains the information that is relevant to the query and only the relevant portion of that document. This extract is 20 times smaller with respect to the two full documents retrieved using semantic search.

From a performance perspective, if the system uses only the very short extract from Document 2 as context in the RAG framework, the system returns the correct answer: “11,000 National Guard members were deployed to the capital on January 6,” using GPT 3.5. However, using both excerpts from the two documents above as context in the RAG framework, the system actually produces the wrong answer: “More than 26,000 National Guard members were deployed to the capital on January 6,” using GPT 3.5.

Although cost savings are ancillary to the improved accuracy, the cost savings are also at a factor of 2× which stem from the compressed context, as well as the improvement of response quality. Indeed, cost saving can also be higher for more expensive LLMs (e.g., for GPT4-o is about a factor of 3×), for larger number of retrieved docs (2x in our case) or larger text chunks. Testing has shown that the above approach reduces costs on an order of 2-3× with an accuracy improvement of approximately 2×.

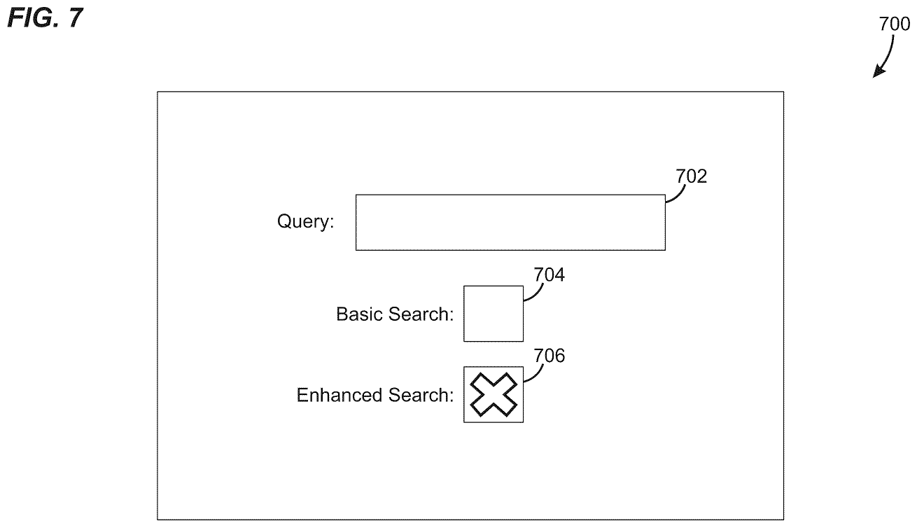

FIG. 7 illustrates an example user interface 700 for entry of a query, in various implementations. As shown, a user of user interface 700 may enter a query into field 702 for processing using the techniques herein. In addition, user interface 700 may include option 704 and option 706 that allow the user to selectively activate or deactivate the contextual-awareness of the RAG system. More specifically, if the user selects option 704, the system may perform a basic search without the contextual compression techniques herein. Conversely, if the user selects option 706, the system may perform an enhanced search using contextual compression based on the input query. Indeed, while the techniques herein may lead to better system performance with respect to its generated answers, using the contextual compression herein may also come at a tradeoff of greater latency. Thus, in some instances, the system may allow the user to selectively enable its functionality when entering an input query.

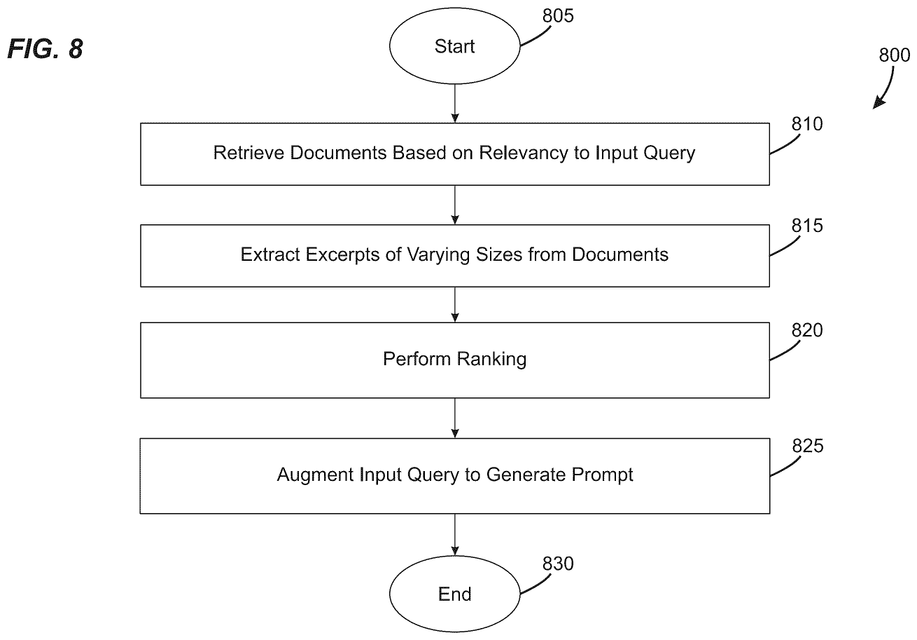

FIG. 8 illustrates an example of a simplified procedure for generating an output in a RAG system, in accordance with one or more implementations described herein. For example, a non-generic, specifically configured device (e.g., device 200), may perform procedure 800 (e.g., a method) by executing stored instructions (e.g., AI process 248).

The procedure 800 may start at step 805, and continues to step 810, where, as described in greater detail above, the device (e.g., a controller, server, etc.) may retrieve a set of documents based on their relevancy to an input query from a user interface. In some implementations, the device retrieves the set of documents from a larger set of documents based on their relevancy to the input query.

At step 815, as detailed above, the device may extract excerpts of varying sizes from the set of documents that are relevant to the input query. In various implementations, the device may also rank the set of documents based on their relevancy to the input query, wherein the device extracts the excerpts based on this ranking. In some implementations, the device may provide the set of documents to a user interface for review and receive, from the user interface, a selection of the set of documents, prior to extracting the excerpts. In various implementations, the varying sizes comprise at least one of: a singular sentence, a paragraph, or a plurality of paragraphs. In one implementation, the device extracts the excerpts from the set of documents based in part on a request associated with the input query to augment it using context-aware retrieval augmented generation (RAG).

At step 820, the device may perform a ranking of the excerpts based on their relevancy to the input query, as described in greater detail above. For instance, the device may perform the ranking based on a measure of the semantic similarity between the documents and the input query.

At step 825, as detailed above, the device may augment, based on the ranking, the input query based on one or more of the excerpts to form a prompt for input to a language model. In various implementations, the language model is a large language model (LLM). The device may also provide, and to a user interface, an output generated by the language model in response to the prompt. In one implementation, the device may also generate summaries of the set of documents based on their excerpts, wherein the device uses the summaries to augment the input query. In a further implementation, the device may also store the excerpts for future augmentation of another input query.

Procedure 800 may then end at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for an intelligent, customizable RAG system with contextual compression, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
retrieving, by a device, a set of documents based on their relevancy to an input query from a user interface;
extracting, by the device, excerpts of varying sizes from the set of documents that are relevant to the input query, wherein the extracting filters information irrelevant to the input query from the set of documents;
performing, by the device, a ranking of the excerpts based on their relevancy to the input query; and
augmenting, by the device and based on the ranking, the input query based on one or more of the excerpts to form a prompt for input to a language model.

2. The method as in claim 1, wherein the language model is a large language model (LLM).

3. The method as in claim 1, further comprising:
providing, by the device and to a user interface, an output generated by the language model in response to the prompt.

4. The method as in claim 1, further comprising:
ranking the set of documents based on their relevancy to the input query, wherein the device extracts the excerpts based on this ranking.

5. The method as in claim 1, further comprising:
providing, by the device, the set of documents to a user interface for review; and
receiving, by the device and from the user interface, a selection of the set of documents, prior to extracting the excerpts.

6. The method as in claim 1, further comprising:
generating summaries of the set of documents based on their excerpts, wherein the device uses the summaries to augment the input query.

7. The method as in claim 1, wherein the varying sizes comprise at least one of: a singular sentence, a paragraph, or a plurality of paragraphs.

8. The method as in claim 1, wherein the device extracts the excerpts from the set of documents based in part on a request associated with the input query to augment it using context-aware retrieval augmented generation (RAG).

9. The method as in claim 1, wherein the device retrieves the set of documents from a larger set of documents based on their relevancy to the input query.

10. The method as in claim 1, further comprising:
storing, by the device, the excerpts for future augmentation of another input query.

11. An apparatus, comprising:
one or more network interfaces;
a processor coupled to the one or more network interfaces and configured to execute one or more processes; and
a memory configured to store a process that is executable by the processor, the process when executed configured to:
retrieve a set of documents based on their relevancy to an input query from a user interface;
extract excerpts of varying sizes from the set of documents that are relevant to the input query, wherein the extracting filters information irrelevant to the input query from the set of documents;
perform a ranking of the excerpts based on their relevancy to the input query; and
augment, based on the ranking, the input query based on one or more of the excerpts to form a prompt for input to a language model.

12. The apparatus as in claim 11, wherein the language model is a large language model (LLM).

13. The apparatus as in claim 11, wherein the process when executed is further configured to:
provide, to a user interface, an output generated by the language model in response to the prompt.

14. The apparatus as in claim 11, wherein the process when executed is further configured to:
rank the set of documents based on their relevancy to the input query, wherein the apparatus extracts the excerpts based on this ranking.

15. The apparatus as in claim 11, wherein the process when executed is further configured to:
provide the set of documents to a user interface for review; and
receive, from the user interface, a selection of the set of documents, prior to extracting the excerpts.

16. The apparatus as in claim 11, wherein the process when executed is further configured to:
generate summaries of the set of documents based on their excerpts, wherein the apparatus uses the summaries to augment the input query.

17. The apparatus as in claim 11, wherein the varying sizes comprise at least one of: a singular sentence, a paragraph, or a plurality of paragraphs.

18. The apparatus as in claim 11, wherein the apparatus extracts the excerpts from the set of documents based in part on a request associated with the input query to augment it using context-aware retrieval augmented generation (RAG).

19. The apparatus as in claim 11, wherein the apparatus retrieves the set of documents from a larger set of documents based on their relevancy to the input query.

20. A tangible, non-transitory, computer-readable medium storing program instructions that cause a device to execute a process comprising:
retrieving, by a device, a set of documents based on their relevancy to an input query from a user interface;
extracting, by the device, excerpts of varying sizes from the set of documents that are relevant to the input query, wherein the extracting filters information irrelevant to the input query from the set of documents;
performing, by the device, a ranking of the excerpts based on their relevancy to the input query; and
augmenting, by the device and based on the ranking, the input query based on one or more of the excerpts to form a prompt for input to a language model.
